(19) United States
(12) Patent Application Publication
(10) Pub. No.: US 2007/0050312 A1
(43) Pub. Date: Mar. 1, 2007

(54) Apparatus for processing postal logistics using radio frequency identification and method using the same

(75) Inventors: Jeong-Hyun Park, Daejeon (KR); Jong-Heung Park, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics & Telecommunications Research Institute

(21) Appl. No.: 11/317,620

(22) Filed: Dec. 22, 2005

(30) Foreign Application Priority Data
Aug. 24, 2005 (KR) 10-2005-0078014

(51) Int. Cl. G06F 17/00

(52) U.S. Cl. 705/402; 700/225

(57) ABSTRACT

Disclosed herein is an apparatus for processing postal logistics using Radio Frequency Identification (RFID), and a method using the same. The postal logistics processing apparatus includes a postal matter receipt system for registering receipt information of received postal matter, and issuing an RFID tag corresponding to the postal matter receipt information; a postal matter collection system for reading the RFID tag for the postal matter when the postal matter is transported from the postal matter receipt system, and automatically sorting the postal matter; and a postal matter delivery system for receiving the postal matter from the postal matter collection system, reading the RFID tag for the postal matter, and delivering the postal matter to a corresponding postal destination.

### RELATED APPLICATION

The present application is based on, and claims priority from, Korean Application Number 2005-0078014, filed Aug. 24, 2005, the disclosure of which is hereby incorporated by reference herein in its entirety.

### BACKGROUND OF THE INVENTION

1. Field of the Invention

The present invention relates to an apparatus for processing postal logistics and a method using the same, and more particularly to an apparatus for processing postal logistics, which is capable of rapidly processing postal logistics (particularly, a parcel processing service, etc.) via an automated process using Radio Frequency Identification (RFID), and a method using the same.

2. Description of the Related Art

With the advance of computer technologies, the world has been remarkably changed, and automation of the various fields of industry has been accomplished. However, the automation of postal matter handling and sorting operations in a post office is not yet realized. That is, in order to handle and sort the postal matter, the post office employs a conventional method for locally collecting and sorting the postal matters by a person.

Particularly, in handling the parcels, a postal employee performs a series of operations for individually scanning barcodes attached to each parcel when contracting received parcels, manually typing a zip code for sorting the parcels, scanning the barcodes attached to each parcel so as to re-contract the sorted parcels for each destination, and scanning the barcodes attached to each parcel in order to confirm the parcels for each postman with respect to the parcels which arrive at a collection and delivery post office.

Thus, in handling the parcels, much time and manpower is consumed. That is, since the conventional method for handling the parcels is based on the barcode, it takes a lot of time. For example, the required time is as follows: time for receiving the parcel, time for recording only a registration number, printing a barcode label, and attaching the barcode label to the parcel, time for individually scanning the barcode attached to the parcel and contracting the parcel with respect to the parcel and a container for the parcel, time for visually confirming the zip code recorded on the parcel, and for manually typing a zip code of a recipient so as to sort the parcels having arrived at a mail center, time for scanning the barcodes attached to the parcels so as to contract the sorted parcels for each destination, and the like.

In addition, with respect to the parcels having arrived at a delivery post office, a postal employee in the delivery post office scans each barcode attached to the parcels so as to deliver the parcels for each postman. Thus, in handling the parcel using the barcode, it takes a lot of time and manual operations when receiving, manually typing and sorting, contracting and delivering the parcels.

Since the conventional apparatus and method for processing postal logistics is based on the barcode, much time and manpower is consumed when handling the postal logistics (particularly, a parcel processing service) . In addition, errors may occur while processing the postal logistics.

The conventional apparatus and method for processing postal logistics degrades service quality and competitiveness with respect to entire postal logistics regarding the parcel. In addition, in the case of processing the barcode-based postal logistics, it is difficult to accurately compare the real-parcel process with the parcel information process when receiving and sorting the parcel, when contracting the sorted parcels for each destination, and when delivering the parcels having arrived at the collection and delivery post office. Further, it may not be possible to monitor the received and delivered parcel and container for the parcel in real-time.

### SUMMARY OF THE INVENTION

Therefore, the present invention has been made in view of the above problems, and it is an object of the present invention to provide an apparatus for processing postal logistics, which is capable of rapidly processing postal logistics (particularly, a parcel processing service, etc.) via an automated process of the postal logistics, and a method using the same.

It is a further object of the present invention to provide an apparatus for processing postal logistics, which is capable of easily processing postal logistics by decreasing time loss and manpower loss due to barcode attachment and barcode scanning when processing the postal logistics, and a method using the same.

It is another object of the present invention to provide an apparatus for processing postal logistics, which is capable of accurately performing postal matter sorting and comparison operations in a delivery and collection post office when processing the postal logistics, and a method using the same.

It is yet another object of the present invention to provide an apparatus for processing postal logistics, which is capable of monitoring a postal matter receipt and delivery process in real-time, and a method using the same.

In accordance with an aspect of the present invention, the above and other objects can be accomplished by the provision of an apparatus for processing postal logistics using Radio Frequency Identification (RFID), the apparatus comprising: a postal matter receipt system for registering receipt information of received postal matter, and issuing an RFID tag corresponding to the postal matter receipt information; a postal matter collection system for reading the RFID tag for the postal matter when the postal matter is transported from the postal matter receipt system, and automatically sorting the postal matter; and a postal matter delivery system for receiving the postal matter from the postal matter collection system, reading the RFID tag for the postal matter, and delivering the postal matter to a corresponding postal destination.

In accordance with another aspect of the present invention, there is provided a method for processing postal logistics using Radio Frequency Identification (RFID), the method comprising the steps of: a) registering receipt information of postal matter in response to receipt of postal matter, and issuing an RFID tag for the postal matter; b) reading the RFID tag for the postal matter when the postal matter is transported, and automatically sorting the postal matter; and c) receiving the sorted postal matter, reading the RFID tag for the sorted postal matter, and delivering the postal matter to a corresponding postal destination.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating an overall concept of an apparatus for processing postal logistics according to an embodiment of the present invention;

FIGS. 2 to 6 are flow charts illustrating methods for processing postal logistics according to an embodiment of the present invention;

FIGS. 7 to 10 are schematic block diagrams illustrating the configuration of a postal matter receipt system according to an embodiment of the present invention;

FIGS. 11 to 14 are schematic block diagrams illustrating the configuration of a postal matter collection system according to an embodiment of the present invention;

FIG. 15 is a schematic block diagram illustrating the configuration of a postal matter delivery system according to an embodiment of the present invention; and

FIGS. 16 to 26 are views illustrating display screens of an apparatus for processing postal logistics according to an embodiment of the present invention.

### DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings.

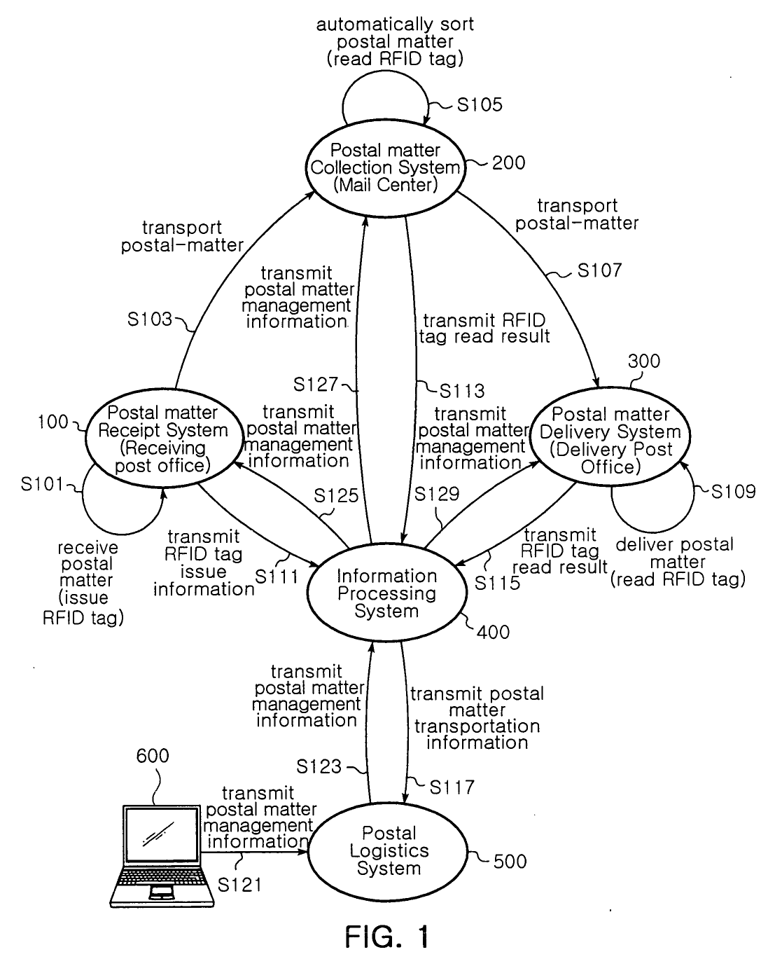

FIG. 1 is a view illustrating an overall concept of an apparatus for processing postal logistics according to an embodiment of the present invention. Referring to FIG. 1, the postal logistics processing apparatus according to the embodiment of the present invention includes a postal matter receipt system 100 arranged in a receiving post office which receives postal matters to be transported; a postal matter collection system 200 arranged in a mail center which receives the postal matters transported from a plurality of receiving post offices and collects to sort the postal matters; a postal matter delivery system 300 arranged in a delivery post office which receives the postal matters transported from the mail center and delivers the postal matters to corresponding destinations; an information processing system 400 for managing postal logistics-related information of the above systems 100, 200 and 300; and a postal logistics system 500 for managing overall information of the postal logistics processing apparatus.

The postal logistics processing apparatus according to the embodiment of the present invention may further include a tagging system (not shown) for storing an identification number of a container with respect to the postal matter such as a parcel, etc. in an RFID tag when the supply of the container is requested. In addition, the postal logistics processing apparatus according to the embodiment of the present invention may further include a real-time monitoring system (not shown) for monitoring the processed statuses of the above systems in real-time. It is preferred that the real-time monitoring system receives the postal logistics processing-related information of the above systems from the information processing system 400, and displays the postal logistics processing-related information, wherein the real-time monitoring system (not shown) may be coupled with the above systems. That is, the real-time monitoring system (not shown) may be installed at any one of the receiving post office, the mail center and the delivery post office, and must be coupled with the postal matter receipt system 100, the postal matter collection system 200 and the postal matter delivery system 300.

The postal logistics processing apparatus having the above configuration according to the embodiment of the present invention operates as follows.

To begin with, when the postal matter (for example, a parcel) is received in the receiving post office, the postal matter receipt system 100 arranged in the receiving post office registers postal matter receipt information, and issues an RFID tag corresponding to the postal matter (S101). That is, the postal matter receipt system 100 registers the postal matter receipt information including a registration number of the received postal matter, a zip code of a destination, an identification number of a container and information for an office nametag, and then issues the RFID tag in which the postal matter receipt information is stored. At this time, it is preferred that the postal matter receipt system 100 generates the RFID tag, prints an RFID label corresponding to the RFID tag, and attaches the label to the corresponding postal matter.

Then, when the postal matter received through the postal matter receipt system 100 is transported to the mail center (S103), the postal matter collection system 200 arranged in the mail center reads the RFID tag for the postal matter, and automatically sorts the postal matter (S105). For example, the postal matter collection system 200 reads the zip code of a destination included in the RFID tag, and automatically sorts the postal matter for each destination on the basis of the zip code. In addition, the postal matter collection system 200 determines the destination of the postal matter on the basis of the read result, and transports the corresponding postal matter to a corresponding delivery post office (S107).

Meanwhile, the postal matter delivery system 300, which is arranged in the delivery post office which receives the postal matter, reads the RFID tag attached to the postal matter and delivers the postal matter to the corresponding destination of the postal matter (S109).

In the postal matter processing procedures, the above systems, that is, the postal matter receipt system 100, the postal matter collection system 200 and the postal matter delivery system 300 respectively transmit RFID tag information to the information processing system 400 in real-time, wherein the RFID tag information is issued or read when the postal matter is received or transported. For example, the postal matter receipt system 100 transmits RFID tag issue information to the information processing system 400 (S111), and the postal matter collection system 200 and the postal matter delivery system 300 respectively transmit an RFID tag reading result, that is, an RFID tag information, to the information processing system 400, wherein the RFID tag is attached to the postal matter which is transported to the mail center and the delivery post office (S113, S115). Then, the information processing system 400 confirms corresponding postal matter transportation information on the basis of the transmitted RFID tag information, and transmits the postal matter transportation information to the postal logistics system 500 (S117).

The postal logistics system 500, which receives the postal matter transportation information, displays the postal matter transportation information through a user terminal (for example, a PC, etc.), the real-time monitoring system, or a web server. Then, the user can confirm the postal matter transportation information in real-time. In addition, in a case where the real-time monitoring system (not shown) is included in the postal logistics processing apparatus, the information processing system 400 transmits the postal matter transportation information to the real-time monitoring system (not shown), and thereby the postal matter transportation information may be monitored in real-time at the place where the real-time monitoring system is arranged.

In addition, when postal matter management information is inputted from a user terminal 600 which is connected to the postal logistics system 500 via a dedicated line (S121), the postal logistics system 500 transmits the postal matter management information to the information processing system 400 (S123), and then the information processing system 400 transmits the postal matter management information to each corresponding system (for example, the postal matter receipt system 100, the postal matter collection system 200 or the postal matter delivery system 300 (S125, S127 and S129). In addition, it is preferred that the postal logistics system 500 transmits the postal matter transportation information, which is transported from each corresponding system, to each corresponding destination of the postal matters. At this time, in order to determine whether the postal matter is normally transported to the destination, the postal matter actually transported to the destination is compared with the postal matter transportation information transmitted through the postal logistics system 500.

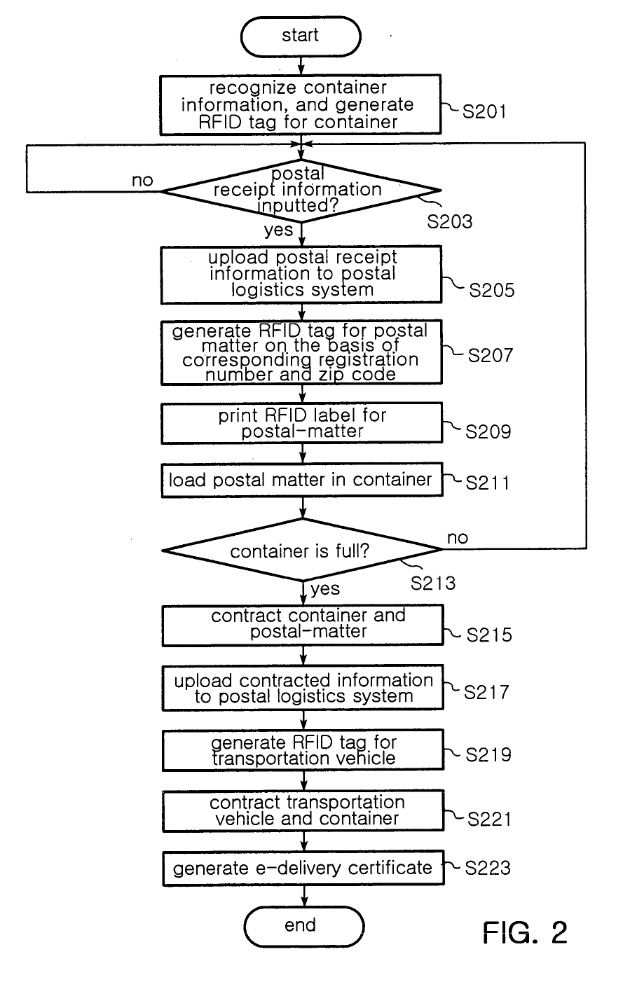

FIGS. 2 to 6 are flow charts illustrating methods for processing postal logistics according to an embodiment of the present invention.

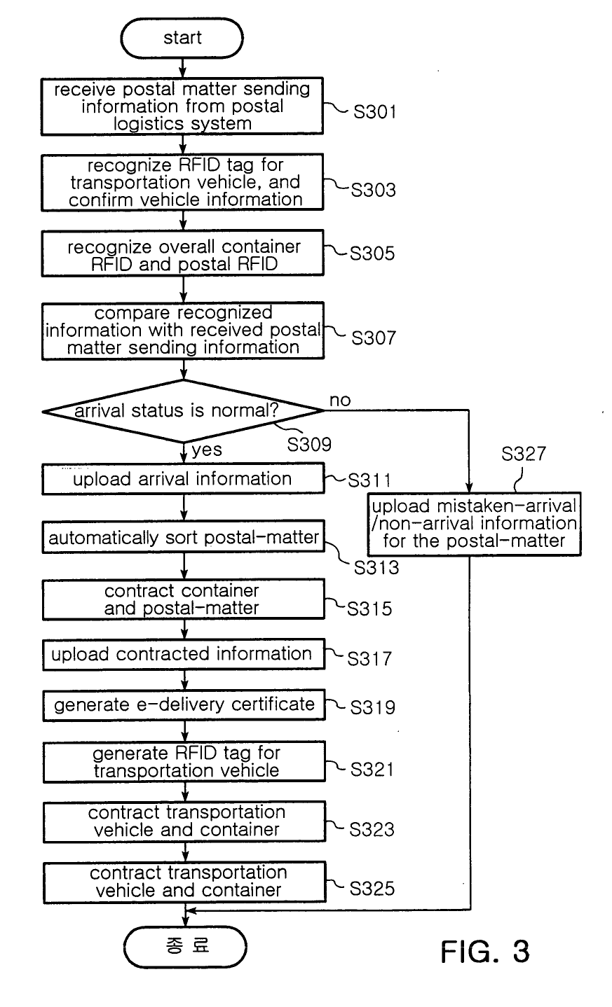

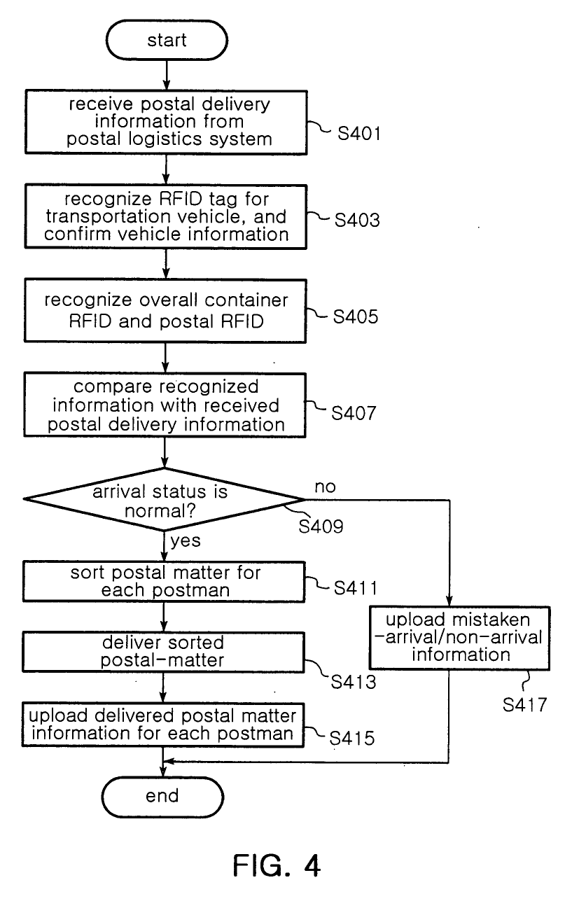

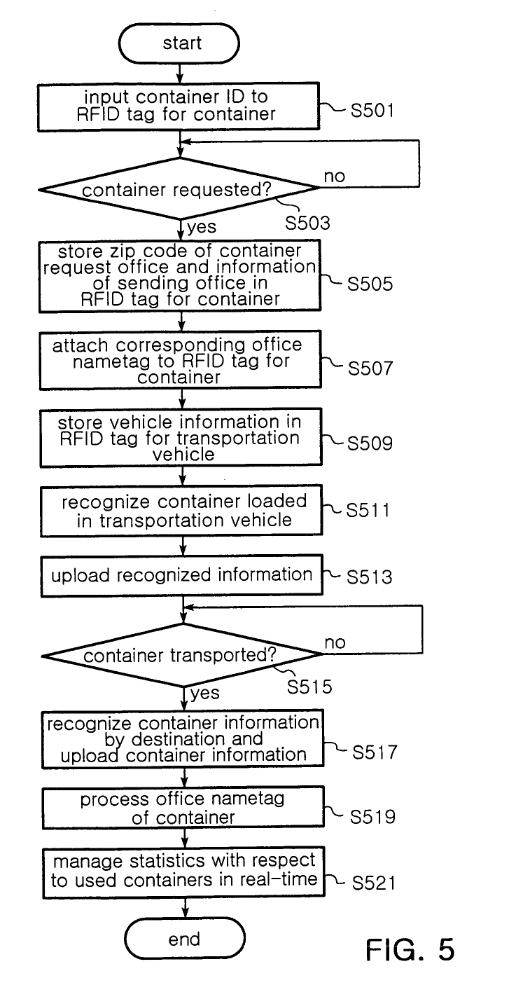

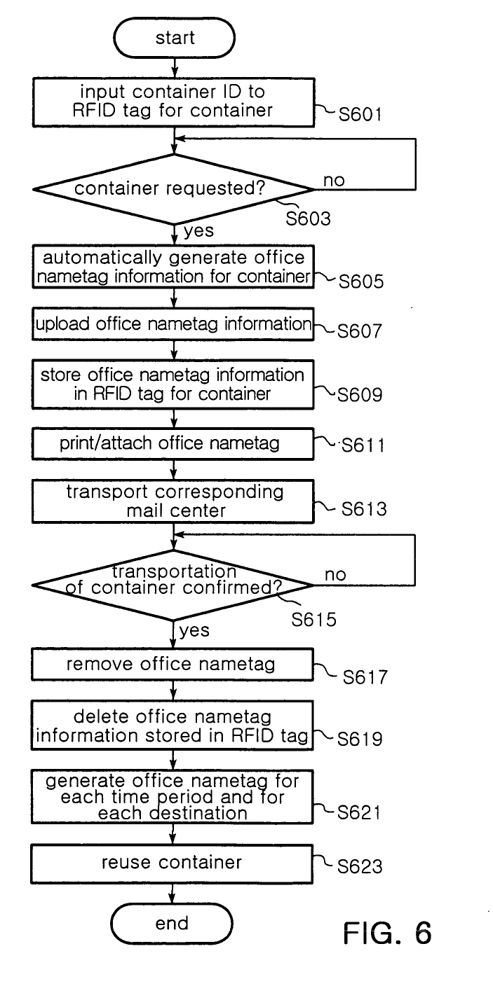

FIG. 2 is a flow chart illustrating a postal matter receipt process in the receiving post office, FIG. 3 is a flow chart illustrating a postal matter collection and sorting process in the mail center, and FIG. 4 is a flow chart illustrating a postal matter delivery process in the delivery post office. FIG. 5 is a flow chart illustrating a method for managing a container which is required for processing RFID-based postal logistics according to an embodiment of the present invention, and FIG. 6 is a flow chart illustrating a method for generating and applying an office nametag for a container which is required for processing RFID-based postal logistics according to an embodiment of the present invention.

Referring to FIG. 1 and 2, a postal matter receipt process in the receiving post office is as follows. To begin with, the postal matter receipt system 100 arranged in the receiving post office recognizes information for a container required for transporting the postal matter, and generates an RFID tag for the container on the basis of the container information (S201). For example, it is preferred that the postal matter receipt system 100 recognizes an identification number for the container, generates the RFID tag which stores the identification number for the container, prints an RFID label corresponding to the RFID tag, and attaches the RFID label to the container. This operation is required prior to loading the postal matter when the postal matter is received later.

Then, when the postal matter (for example, a parcel) is received in the receiving post office and the postal matter receipt information is inputted in the postal matter receipt system 100 (S203), the postal matter receipt system 100 uploads the postal matter receipt information to the postal logistics system 500 (S205). At this time, it is preferred that the postal matter receipt system 100 uploads the postal matter receipt information to the postal logistics system 500 via the information processing system 400 as shown in FIG. 1.

In addition, the postal matter receipt system 100 generates an RFID tag for the postal matter on the basis of a registration number and a zip code corresponding to the postal matter receipt information (S207), prints an RFID label for the postal matter (S209), and then attaches the RFID label to the corresponding postal matter. Then, the postal matter receipt system 100 loads the corresponding postal matter in the container prepared in Step S201 (S211).

Next, the postal matter receipt system 100 determines whether the container is in a ‘full’ state (S213). When the container is in the ‘full’ state, that is, when the container is full of the postal matters, the postal matter receipt system 100 contracts the container and the postal matters loaded in the container so as to generate contracted information (S215), and then uploads the contracted information to the postal logistics system 500 (S217).

When the contracting process is completed with respect to the container and the corresponding postal matters, the postal matter receipt system 100 generates an RFID tag for a transportation vehicle which transports the container (S219). Then, the postal matter receipt system 100 contracts the container and the transportation vehicle (S221), and automatically generates an e-delivery certificate (S223).

Meanwhile, when the container is loaded in the transportation vehicle, preferably, the postal matter receipt system 100 further performs automatically overall recognition of the corresponding postal matter and the container, and uploads postal matter receipt-related information to the postal logistics system 500.

Referring to FIGS. 1 and 3, the postal matter collection and sorting process in the mail center is as follows. To begin with, the postal matter collection system 200 arranged in the mail center receives postal matter sending information from the postal logistics system 500 (S301). In this case, it is preferred that, when the postal logistics system 500 receives the postal matter sending information, which is transmitted to the corresponding mail center, from any receiving post office, the postal logistics system 500 transmits the postal matter sending information to the postal matter collection system 200 corresponding to the corresponding mail center. At this time, it is preferred that the received postal matter sending information includes overall RFID tag information generated in the postal matter receipt system 100. For example, preferably, the overall RFID tag information includes an RFID tag for the postal matter, an RFID tag for the container and an RFID tag for the transportation vehicle.

Meanwhile, when the postal matter is transported to the mail center, the postal matter collection system 200 recognizes the RFID tag for the transportation vehicle, and confirms information for the transportation vehicle (S303). For instance, the postal matter collection system 200 confirms a registration number plate of the transportation vehicle.

In addition, the postal matter collection system 200 performs overall recognition of the RFID tag for the container loaded in the transportation vehicle and the RFID tag for the postal matter loaded in the container (S305).

Then, the postal matter collection system 200 compares the postal matter sending information received in Step S301 with the information (that is, the transportation vehicle information, the RFID tag for the container and the RFID tag for the postal matter) recognized in Steps S303 and S305 (S307). At this time, the postal matter collection system 200 determines whether the postal matter, the container and the transportation vehicle are normally arrived on the basis of the comparison result.

According to the comparison result, when the postal matter sending information received in Step S301 is equal to the information (that is, the transportation vehicle information, the RFID tag for the container and the RFID tag for the postal matter) recognized in Steps S303 and S305, the postal matter collection system 200 determines that the postal matter, the container and the transportation vehicle are normally arrived. Otherwise, the postal matter collection system 200 determines that the postal matter, the container or the transportation vehicle is not normally arrived (S309).

When it is determined that postal matter, the container and the transportation vehicle are normally arrived according to the determination result of Step S309, the postal matter collection system 200 uploads arrival information to the postal logistics system 500 (S311). Then, the postal matter collection system 200 automatically sorts the arrived postal matter on the basis of the RFID tag information (S313). For example, the postal matter collection system 200 automatically sorts the postal matters for each destination on the basis of the zip code information of the destination stored in the RFID tag which is attached to the postal matter. At this time, it is preferred that the sorted postal matters are loaded in each different container (for example, a container for each destination).

Next, the postal matter collection system 200 contracts the container and the postal matter (S315) so as to generate contracted information, uploads the contracted information to the postal logistics system 500 (S317), and generates an e-delivery certificate (S319).

When the above contracting process is completed with respect to the container and the postal matter (parcel) sorted for each destination, the postal matter collection system 200 generates an RFID tag for the transportation vehicle, wherein the transportation vehicle transports the container (S321). Then, the postal matter collection system 200 contracts the transportation vehicle and the container (S323), and generates an e-delivery certificate (S325).

Meanwhile, when the container is loaded in the transportation vehicle, preferably, the postal matter collection system 200 further performs automatically overall recognition of the postal matter and the container which are sorted for each destination from a postal matter invoice, and uploads postal matter collection-related information to the postal logistics system 500.

When it is determined that postal matter, the container and the transportation vehicle are not normally arrived according to the determination result of Step S309, the postal matter collection system 200 uploads information of mistaken-arrival or non-arrival, or mis-sending or non-sending to the postal logistics system 500 (S327). In this case, it is preferred that the postal logistics system 500 displays the corresponding information (for example, mistaken-arrival or non-arrival information of the postal matter, or mis-sending or non-sending information of the postal matter) on the real-time monitoring system.

Referring to FIGS. 1 and 4, the postal matter delivery process in the delivery post office is as follows. To begin with, the postal matter delivery system 300 arranged in the delivery post office receives the postal matter sending information from the postal logistics system 500 (S401). In this case, it is preferred that, when the postal logistics system 500 receives the postal matter sending information, which is transmitted to the corresponding delivery post office, from any mail center, the postal logistics system 500 transmits the postal matter sending information to the postal matter delivery system 300 corresponding to the corresponding delivery post office. At this time, it is preferred that the received postal matter sending information includes overall RFID tag information which is generated in the postal matter receipt system 100 and the postal matter collection system 200. For example, preferably, the overall RFID tag information includes the RFID tag for the postal matter, the RFID tag for the container and the RFID tag for the transportation vehicle.

Meanwhile, when the postal matter is transported to the delivery post office, the postal matter delivery system 300 recognizes the RFID tag for the transportation vehicle, and confirms information for the transportation vehicle (S403). For instance, the postal matter delivery system 300 confirms a registration number plate of the transportation vehicle. In addition, the postal matter delivery system 300 performs overall recognition of the RFID tag for the container loaded in the transportation vehicle and the RFID tag for the postal matter loaded in the container (S405).

Then, the postal matter delivery system 300 compares the postal matter sending information received in Step S401 with the information (that is, the transportation vehicle information, the RFID tag for the container and the RFID tag for the postal matter) recognized in Steps S403 and S405 (S407). At this time, the postal matter delivery system 300 determines whether the postal matter, the container and the transportation vehicle are normally arrived on the basis of the comparison result.

According to the comparison result, when the postal matter sending information received in Step S401 is equal to the information (that is, the transportation vehicle information, the RFID tag for the container and the RFID tag for the postal matter) recognized in Steps S403 and S405, the postal matter delivery system 300 determines that the postal matter, the container and the transportation vehicle are normally arrived. Otherwise, the postal matter delivery system 300 determines that the postal matter, the container or the transportation vehicle is not normally arrived (S409).

When it is determined that postal matter, the container and the transportation vehicle are normally arrived according to the determination result of Step S409, the postal matter delivery system 300 sorts the arrived postal matter for each postman on the basis of the corresponding RFID tag information (S411). For example, the postal matter delivery system 300 sorts the postal matter for each potential postman for the destination on the basis of final destination information of the postal matter.

Then, the postal matter delivery system 300 performs overall recognition of the RFID tag attached to the postal matter sorted for each postman, confirms the postal matter for delivery, determines the delivery order of the postal matter, and delivers the postal matter (S413). In addition, the postal matter delivery system 300 uploads the postal matter information for delivery, which is confirmed for each postman, and the delivered postal matter information to the postal logistics system 500 (S415). At this time, it is preferred that the postal matter delivery system 300 uses a portable terminal which the postman possesses when uploading a delivery result.

When it is determined that postal matter, the container and the transportation vehicle are not normally arrived according to the determination result of Step S409, the postal matter delivery system 300 uploads mistaken-arrival or non-arrival information to the postal logistics system 500 (S417). In this case, it is preferred that the postal logistics system 500 displays the corresponding information (for example, mistaken-arrival or non-arrival information of the postal matter) on the real-time monitoring system.

FIG. 5 is a flow chart illustrating a method for managing a container which is required for processing RFID-based postal logistics according to an embodiment of the present invention. In detail, when a supply of an empty container is requested, a process for storing in the RFID tag a zip code of a collection and delivery post office, a zip code of a mail center or a zip code of a receiving post office which requests the container ID and the container, and transporting the container is illustrated as shown in FIG. 5.

Referring to FIG. 5, the method for managing a container which is required for processing RFID-based postal logistics according to the embodiment of the present invention is as follows.

To begin with, an apparatus/system for managing the container inputs a container identification number (ID) to the container (S501). When the container is requested from the collection and delivery post office, the mail center, the receiving post office, and the like (S503), the apparatus/system for managing the container stores a zip code of the container requesting office (for example, the mail center, the collection and delivery post office and the receiving post office) and sending office information in the RFID tag for the container (S505). Then, the apparatus/system for managing the container prepares an office nametag corresponding to the RFID tag for the container, and attaches the office nametag to the container (S507). Herein, information with respect to the container requesting office and the zip code of the sending office, etc. are included in the office nametag.

Next, the apparatus/system for managing the container selects a transportation vehicle which transports the container to the collection and delivery post office, the mail center or the receiving post office which requests the container ID and the container, etc., and stores the vehicle information in the RFID tag for the transportation vehicle (S509). Then, when the corresponding container is loaded in the transportation vehicle, the apparatus/system for managing the container recognizes information for the loaded container (S511) and uploads the recognized information to the postal logistics system 500 (S513). Then, when the container is moved to the container requesting office by the transportation vehicle (S515), the container requesting office (that is, a destination) recognizes the RFID tag for the transportation vehicle and the RFID tag for the container, and then uploads the recognized information with respect to the transportation vehicle and the container to the postal logistics system 500 (S517).

Then, the container requesting office compares the arrived content of the container with the sent content of the container. When the arrived content of the container is equal to the sent content of the container, the container requesting office removes the office nametag, resets the RFID tag information for the container, and prepares the container for reuse (S519). In addition, an internal information processing system, a real-time monitoring system or web server arranged in the mail center or other places manages statistics with respect to the empty containers in real-time according to the RFID tag information for container recognized via an RFID reader installed in the mail center or other places (S521).

FIG. 6 is a flow chart illustrating a method for generating and applying an office nametag for a container which is required for processing RFID-based postal logistics according to an embodiment of the present invention.

Referring to FIG. 6, the method for generating and applying the office nametag for the container is as follows.

To begin with, in order to generate the office nametag for the container, an apparatus for managing the office nametag for the container (hereinafter, referred to as an ‘office nametag management apparatus’) inputs container ID to the RFID tag for the container (S601). Then, when the container is requested from the container requesting office such as the collection and delivery post office, the mail center or the receiving post office (S603), the office nametag management apparatus automatically generates office nametag information (for example, a name of the container requesting office, and a zip code of the sending office, etc.) for the container (S605), and uploads the office nametag information to the postal logistics system 500 (S607). In addition, the office nametag management apparatus stores the office nametag information in the RFID tag for the container (S609), prints the office nametag, attaches the office nametag to the container (S6100), and transports the container to the corresponding mail center (container requesting office) (S613). Then, when it is determined that the container transported to the corresponding mail center has normally arrived (S613), the mail center removes the office nametag attached to the container (S617), and deletes the office nametag information stored in the RFID tag for the container (S619). Next, the mail center prepares the office nametag information for each time period such as for each day, for each week, and the like, and for each destination using the office nametag management apparatus (S621), and downloads and uses the office nametag information when the container is actually used or reused (S623). That is, when contracting the container and the postal matter therein such as a parcel or a registered mail, the generated office nametag is used by downloading the office nametag information via the postal logistics system 500 or the office nametag management apparatus, confirming the office nametag information, storing the office nametag information in the RFID tag attached to the container and simultaneously printing the office nametag to attach to the container. This serves to easily and effectively improve conventional methods for generating and applying an office nametag using RFID technologies. According to the above-described process, when the mail center contracts the postal matter and the container sorted for each destination, a process of scanning the office nametag of a present container is omitted. That is, the office nametag management apparatus directly downloads the office nametag information of the container, confirms the office nametag with respect to the corresponding destination, stores the office nametag information in the RFID tag for the container, and simultaneously prints the office nametag for the container.

Thus, the present invention discloses the method for managing an empty container using RFID technologies via the above-described process as shown in FIG. 5, and the method for generating and applying the office nametag for the container using RFID technologies via the above-described process as shown in FIG. 6.

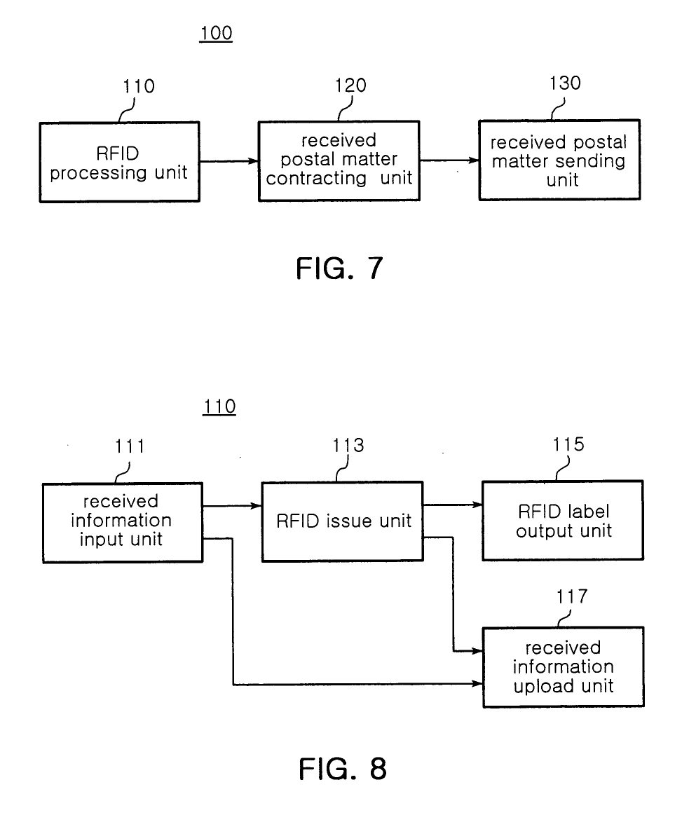

FIGS. 7 to 10 are schematic block diagrams illustrating the configuration of a postal matter receipt system according to an embodiment of the present invention.

FIG. 7 is a block diagram showing the configuration of a postal matter receipt system according to an embodiment of the present invention. Referring to FIG. 7, the postal matter receipt system 100 according to the embodiment of the present invention includes an RFID processing unit 110, a received postal matter contraction unit 120 and a received postal matter sending unit 130.

The RFID processing unit 110 issues an RFID tag corresponding to the received postal matter (for example, a parcel, etc.).

The received postal matter contraction unit 120 automatically contracts the postal matter and the container by confirming an office nametag for the container which loads the received postal matter, storing office nametag information in the RFID tag for the container, and loading the received postal matter in the container.

The received postal matter sending unit 130 transports the received postal matter to a mail center, automatically generates an e-delivery certificate with respect to the transported postal matter, and uploads transported both the e-delivery certificate and postal matter information to the postal logistics system 500.

FIG. 8 is a schematic block diagram with respect to the RFID processing unit 110 of FIG. 7. Referring to FIG. 8, the RFID processing unit 110 includes a receipt information input unit 111, an RFID issue unit 113, an RFID label output unit 115 and a receipt information upload unit 117.

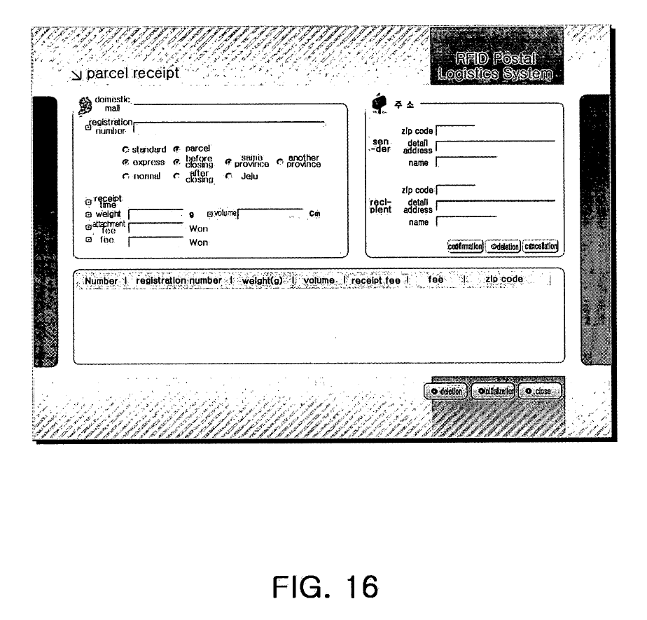

The receipt information input unit 111 provides an interface for inputting the received postal matter information. A display screen for inputting the received information through the receipt information input unit 111 is illustrated in FIG. 16. Referring to FIG. 16, the received information with respect to the RFID tag includes postal matter-related information such as a registration number, a receipt time, a postal matter weight, a dimension, a fee, and the like, and a zip code, an address and a name of a sender and a recipient. The received information is registered to the postal matter receipt system 100 by a receipt information registerer through the interface screen as shown in FIG. 16.

The RFID issue unit 113 issues an RFID tag for corresponding postal matter on the basis of the received information inputted through the receipt information input unit 111. At this time, it is preferred that the RFID tag stores a registered number for identifying the postal matter, and a zip code for sorting a destination to which the postal matter is delivered.

The RFID label output unit 115 outputs an RFID label corresponding to the RFID tag issued through the RFID issue unit 113. In addition, it is preferred that the RFID label output unit 115 attaches the RFID label to the corresponding postal matter.

The receipt information upload unit 117, which is connected to the postal logistics system 500 or the information processing system 400 via a LAN, uploads the received information to the postal logistics system 500 or the information processing system 400. Then, the received information is reflected in a database which is embedded in the postal logistics system 500 or the information processing system 400.

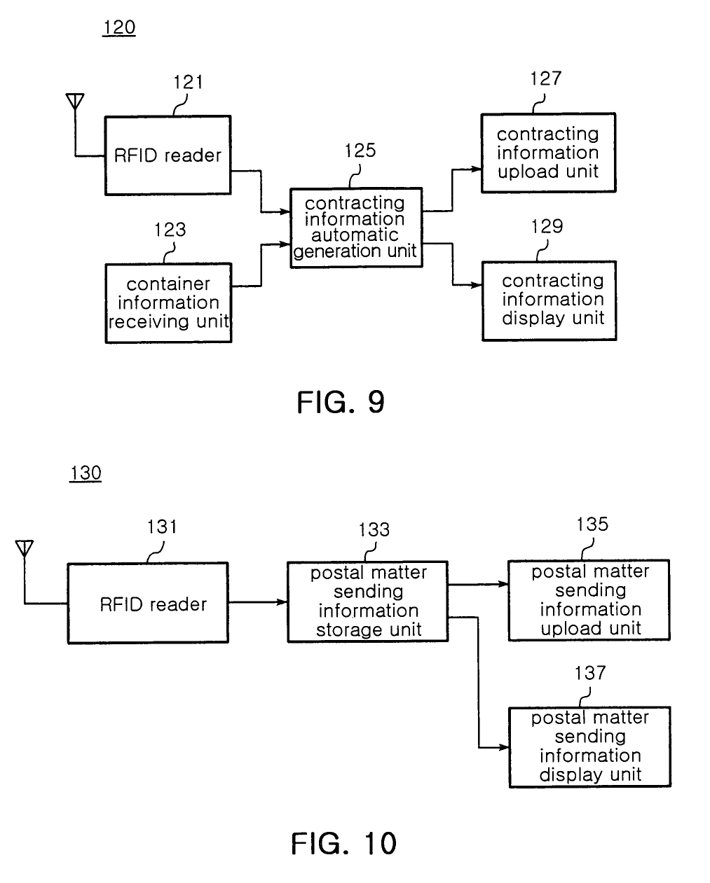

FIG. 9 is a schematic block diagram showing the configuration of the received postal matter contracting unit 120 of FIG. 7. Referring to FIG. 9, the received postal matter contraction unit 120 includes an RFID reader 121, a container information receiving unit 123, a contracting information automatic generation unit 125, a contracting information upload unit 127, and a contracting information display unit 129.

The RFID reader 121 recognizes postal matter receipt information corresponding to the RFID label attached to the received postal matter.

The container information receiving unit 123 recognizes container information attached to the container. At this time, the configuration of the container information receiving unit 123 may be modified according to a type of container information. For example, it is preferred that, when the container information is composed of a ‘barcode’, the container information receiving unit 123 is composed of a barcode scanner, and when the container information is composed of an ‘RFID tag’, the container information receiving unit 123 is composed of an RFID reader.

The contracting information automatic generation unit 125 automatically contracts the received postal matter on the basis of the postal matter receipt information recognized through the RFID reader 121 and the container information recognized through the container information receiving unit 123, and then automatically generates the contracted information.

The contracting information upload unit 127, which is connected to the postal logistics system 500 or the information processing system 400 via a LAN, uploads the contracted information to the postal logistics system 500 or the information processing system 400. Then, the contracted information is reflected in the database which is embedded in the postal logistics system 500 or the information processing system 400.

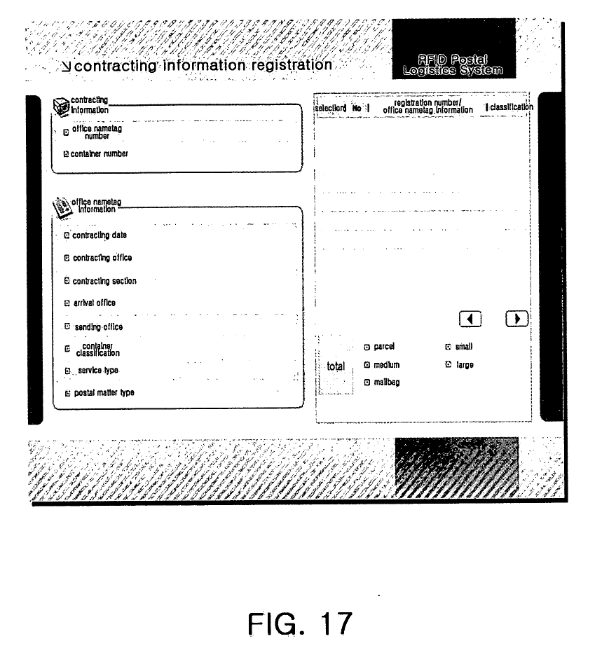

The contracting information display unit 129 receives the contracted information automatically generated through the contracting information automatic generation unit 125, and displays the contracted information. At this time, a display screen for displaying the contracted information through the contracting information display unit 129 is illustrated in FIG. 17. Referring to FIG. 17, the contracted information and the office nametag information are displayed on the display screen, wherein, the contracted information includes an office nametag number and a container number, and the office nametag information includes a contracted time, a contracted office, a contracted section, an arrival office, a sending office, a container type, a service type and a postal matter type. In addition, it is preferred that an area for displaying transportation fee information according to a type, dimension and shape of corresponding postal matter is included in the display screen.

FIG. 10 is a schematic block diagram showing the configuration of the received postal matter sending unit 130 of FIG. 7. Referring to FIG. 10, the received postal matter sending unit 130 includes an RFID reader 131, a postal matter sending information storage unit 133, a postal matter sending information upload unit 135, and a postal matter sending information display unit 137.

The RFID reader 131 recognizes the postal matter sending information corresponding to the RFID label attached to the postal matter automatically contracted through the received postal matter contraction unit 120.

The postal matter sending information storage unit 133 stores the postal matter sending information recognized in the RFID reader 131.

The postal matter sending information upload unit 135 which is connected to the postal logistics system 500 or the information processing system 400 via a LAN, uploads the postal matter sending information stored in the postal matter sending information storage unit 133 to the postal logistics system 500 or the information processing system 400. Then, the postal matter sending information is reflected in the database which is embedded in the postal logistics system 500 or the information processing system 400.

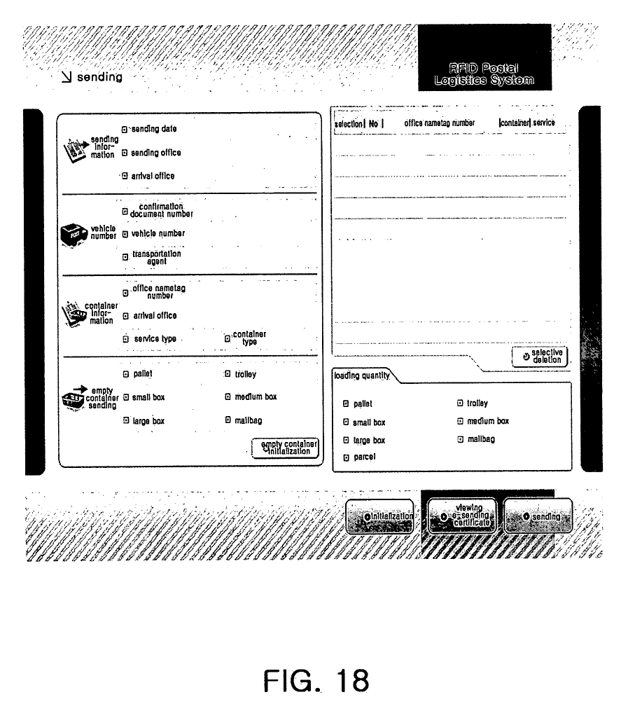

The postal matter sending information display unit 137 displays the postal matter sending information transmitted from the postal matter sending information storage unit 133. At this time, a display screen for displaying the postal matter sending information through postal matter sending information display unit 137 is illustrated in FIG. 18. Referring to FIG. 18, the postal matter sending information which is displayed on the display screen includes sending information, vehicle information, container information, empty container sending information, and loading quantity information, wherein the sending information includes information for a postal matter sending date, a sending office and an arrival office, the vehicle information includes information for a confirmation document number, a vehicle number and transportation agent information, and the container information includes information for an office nametag number, an arrival office, a service type and a container type.

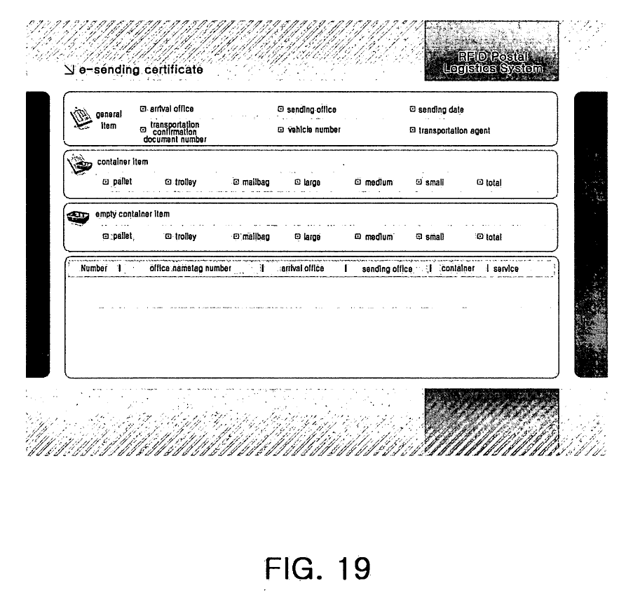

Meanwhile, FIG. 19 is a view illustrating a sending certificate (for example, an e-delivery certificate) generated when the postal matter is transported. Referring to FIG. 19, the e-delivery certificate includes a general item, a container item and an empty container item, wherein the general item includes an arrival office, a sending office, a sending date, a transportation confirmation document number, a vehicle number, and transportation agent information.

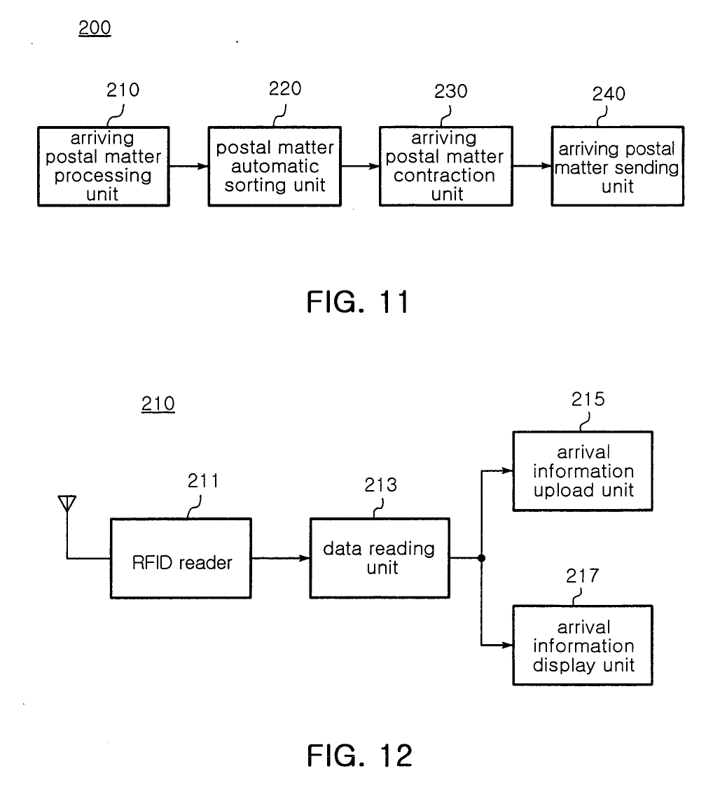

FIGS. 11 to 14 are schematic block diagrams illustrating the configuration of a postal matter collection system according to an embodiment of the present invention.

FIG. 11 is a schematic block diagram showing the configuration of a postal matter collection system according to an embodiment of the present invention. Referring to FIG. 11, the postal matter collection system 200 includes an arriving postal matter processing unit 210, a postal matter automatic sorting unit 220, an arriving postal matter contraction unit 230, and an arriving postal matter sending unit 240.

The arriving postal matter processing unit 210 identifies the RFID tag for the arrived postal matter, stores the RFID tag information, and simultaneously displays the RFID tag information.

The postal matter automatic sorting unit 220 automatically sorts the postal matter on the basis of the RFID tag identified through the arriving postal matter processing unit 210.

The arriving postal matter contraction unit 230 automatically contracts the postal matter sorted through the postal matter automatic sorting unit 220.

The arriving postal matter sending unit 240 sends the postal matter automatically contracted through the arriving postal matter contraction unit 230. For example, the arriving postal matter sending unit 240 may generate an e-sending certificate and an e-delivery certificate. In addition, with respect to the postal matter (parcel) and the container which are transported to the receiving post office or other mail centers, it is possible to accurately know of their status in real-time and adequately performing statistics management of the used containers. In addition, by performing an overall recognition of the postal matter and container transported for each destination, it is possible to automatically sort and accurately compare the recognized information with the contracted information, and thereby it is possible to prevent the mis-sending or non-sending of the postal matter.

FIG. 12 is a schematic block diagram showing the configuration of an arriving postal matter processing unit 210. Referring to FIG. 12, the arriving postal matter processing unit 210 includes an RFID reader 211, a data reading unit 213, an arrival information upload unit 215 and an arrival information display unit 217.

The RFID reader 211 recognizes arrival information of the postal matter corresponding to the RFID label attached to the postal matter, wherein, the postal matter received from the receiving post office 100 is transported to the mail center 200.

The data reading unit 213 reads the postal matter arrival information recognized through the RFID reader 211. That is, the data reading unit 213 confirms the vehicle information on the basis of the postal matter arrival information, and automatically performs an overall recognition of the arrived postal matter and container when the postal matter and the container are unloaded from the transportation vehicle.

The arrival information upload unit 215, which is connected to the postal logistics system 500 or the information processing system 400 via a LAN, uploads the arrival information read through the data reading unit 213 to the postal logistics system 500 or the information processing system 400. Then, the arrival information is reflected in a database which is embedded in the postal logistics system 500 or the information processing system 400. That is, it is possible to determine whether the postal matter is mistaken-arrived or non-arrived on the basis of the uploaded data. Thus, with respect to the postal matter (parcel) and the container which are transported to the receiving post office or other mail centers, it is possible to accurately know of their status in real-time and adequately perform statistics management of the used containers. At this time, it is preferred that the office nametag information for the container is reset so as to reuse the container.

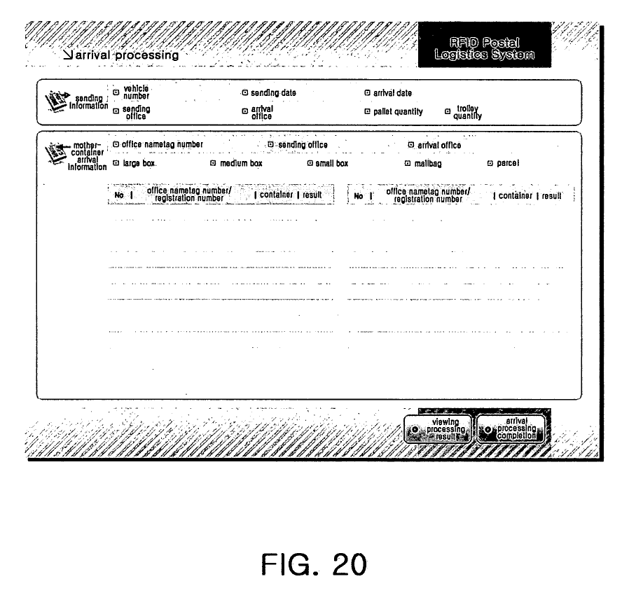

The arrival information display unit 217 displays the arrival information read through the data reading unit 213. At this time, a display screen for displaying the arrival information is illustrated in FIG. 20. Referring to FIG. 20, sending information and mother-container arrival information are displayed on the display screen, wherein, the sending information includes vehicle information, sending date, arrival date, a sending office, an arrival office and the number of pallets, etc., and the mother-container arrival information includes an office nametag number, a sending office, an arrival office, a large box, a medium box, a small box, a postbag and a postal matter (parcel) information.

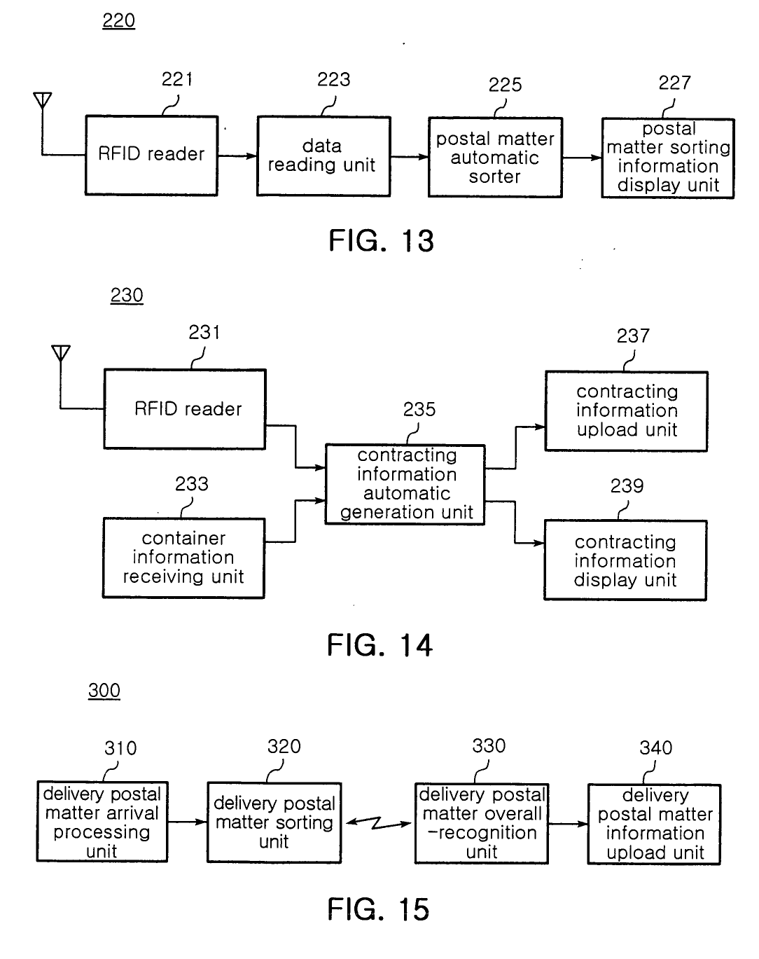

FIG. 13 is a schematic block diagram showing the configuration of the postal matter automatic sorting unit 220 of FIG. 11. Referring to FIG. 13, the postal matter automatic sorting unit 220 includes an RFID reader 221, a data reading unit 223, a postal matter automatic sorter 225, and a postal matter sorting information display unit 227.

The RFID reader 221 recognizes the arrival information of the postal matter corresponding to the RFID label attached to the postal matter received through the arriving postal matter processing unit 210.

The data reading unit 223 reads the postal matter arrival information recognized through the RFID reader 221.

The postal matter automatic sorter 225 automatically sorts the arrived postal matter on the basis of the postal matter arrival information read through the data reading unit 223.

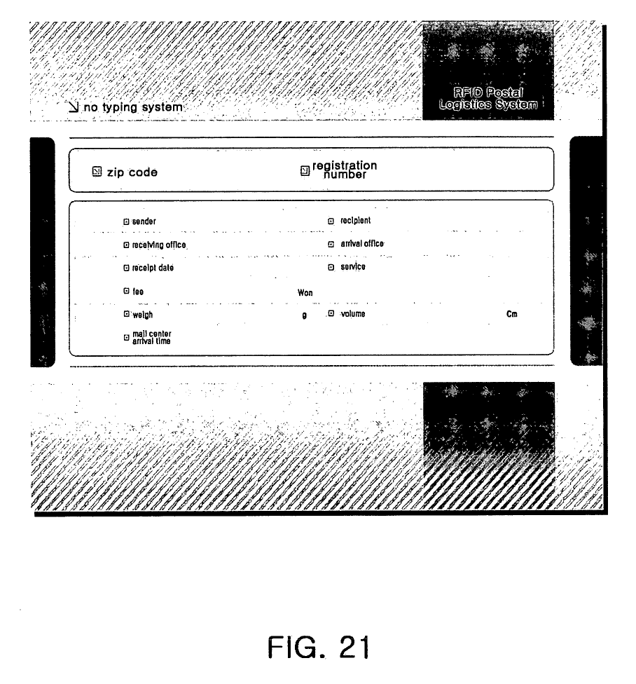

The postal matter sorting information display unit 227 displays postal matter sorting information with respect to the postal matter sorted through the postal matter automatic sorter 225. At this time, a display screen for displaying the postal matter sorting information is illustrated in FIG. 21. Referring to FIG. 21, the sorting information with respect to the arrived postal matter includes a zip code and a registration number, and also includes information for a sender, a recipient, a receipt office, an arrival office, a receipt date and a fee, etc.

FIG. 14 is a schematic block diagram showing the configuration of the arriving postal matter contraction unit 230 of FIG. 11. Referring to FIG. 14, the arriving postal matter contraction unit 230 includes an RFID reader 231, a container information receiving unit 233, a contracting information automatic generation unit 235, a contracting information upload unit 237, and a contracting information display unit 239.

The RFID reader 231 recognizes destination information for the postal matter corresponding to the RFID label attached to the postal matter automatically sorted through the postal matter automatic sorting unit 220.

The container information receiving unit 233 recognizes container information which is used when the postal matter is transported. Herein, the container information receiving unit 233 may be modified according to a type of container information. For example, it is preferred that, when the container information is composed of a ‘barcode’, the container information receiving unit 233 is composed of a barcode scanner, and when the container information is composed of an ‘RFID tag’, the container information receiving unit 233 is composed of an RFID reader.

The contracting information automatic generation unit 235 automatically contracts the arrived postal matter on the basis of the postal matter receipt information recognized through the RFID reader 231 and the container information recognized through the container information receiving unit 233, and then automatically generates the contracted information.

The contracting information upload unit 237, which is connected to the postal logistics system 500 or the information processing system 400 via a LAN, uploads the contracted information to the postal logistics system 500 or the information processing system 400. Then, the contracted information is reflected in the database which is embedded in the postal logistics system 500 or the information processing system 400.

The contracting information display unit 239 receives the contracted information automatically contracted through the contracting information automatic generation unit 235, and displays the contracted information.

At this time, it is preferred that the arriving postal matter (parcel) contraction unit 230 sorted for each destination is composed of a ceiling type RFID reader or a portable RFID terminal (for example, a PDA).

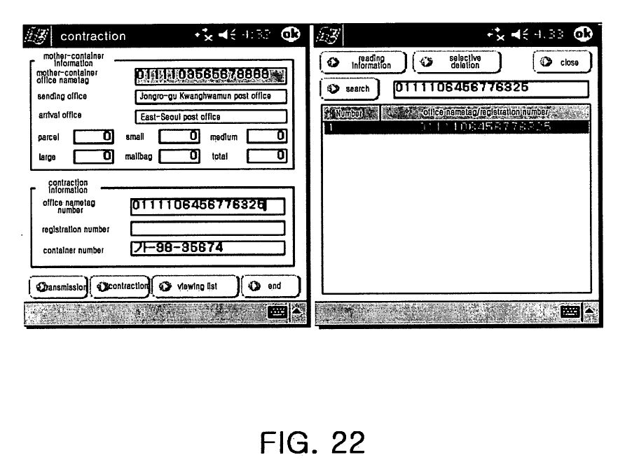

A display screen for displaying the contracted information through contracting information display unit 239 is illustrated in FIG. 22. Particularly, when the arriving postal matter contraction unit 230 is composed of the portable RFID terminal, corresponding display screen thereto is illustrated. Referring to FIG. 22, the contracted information display screen includes a mother-container information area, a contracted information area including the contracted information, and a contracted list area including a list with respect to a contracted postal matter.

FIG. 15 is a schematic block diagram showing the configuration of the postal matter delivery system according to an embodiment of the present invention. Referring to FIG. 15, the postal matter delivery system according to an embodiment of the present invention includes a delivery postal matter arrival processing unit 310, a delivery postal matter sorting unit 320, a delivery postal matter overall-recognition unit 330, and a delivery postal matter information upload unit 340.

The delivery postal matter arrival processing unit 310 recognizes delivery postal matter information by recognizing the RFID label attached to the arrived postal matter, and determines whether the arrived postal matter is mistaken-arrived or non-arrived by comparing the delivery postal matter information with the information transmitter through the mail center. For example, by automatically performing an overall recognition of the arrived postal matter and container when the postal matter and the container having arrived at the delivery post office are unloaded from the transportation vehicle, it is possible to confirm the postal matter and container transported from the mail center. In addition, the container containing delivery postal matters is reusable by resetting the office nametag stored in the RFID tag attached to the container.

The delivery postal matter sorting unit 320 automatically sorts the delivery postal matters when the delivery postal matters are normally arrived according to a processing result of the delivery postal matter arrival processing unit 310. For example, the postal matters are automatically sorted for each postman.

The delivery postal matter overall-recognition unit 330 performs an overall recognition of the automatically sorted postal matters. For example, the automatically sorted postal matters are overall-recognized using the portable RFID terminal (for example, a PDA, etc.) which is distributed for each postman.

The delivery postal matter information upload unit 340, which is connected to the postal logistics system 500 via a wireless-LAN, receives overall-recognition information for the delivery postal matters, and uploads the overall-recognition information so as to compare the postal matter transported through the mail center with the received postal mater.

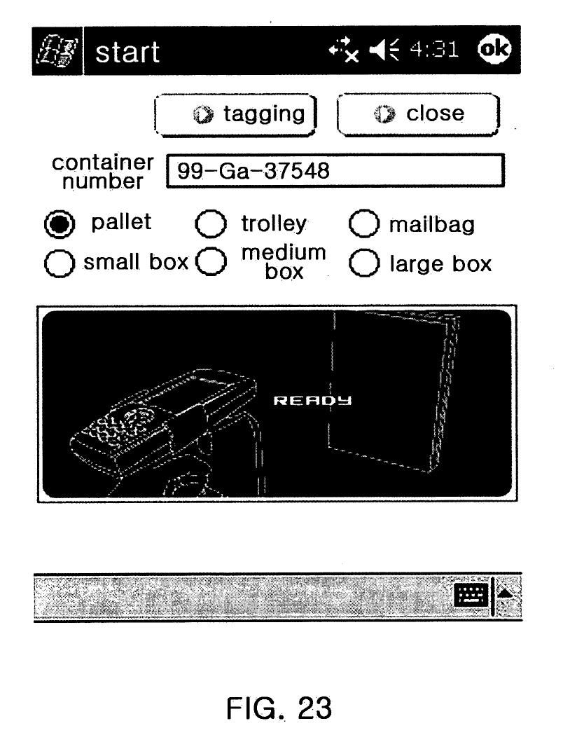

FIG. 23 is a view illustrating a screen for displaying a process state of a tagging system according to an embodiment of the present invention. The tagging system is a system for storing the container identification number defined for the container to the RFID tag for the container when the container is requested for use or when the container is firstly supplied. That is, the tagging system allocates the container identification number to the container, wherein the container is any one type among a pallet, a trolley, a mailbag, a small box, a medium box and a large box. As shown in FIG. 23, the container is a pallet type, and the container identification number is allocated to ‘99-Ga-37548’.

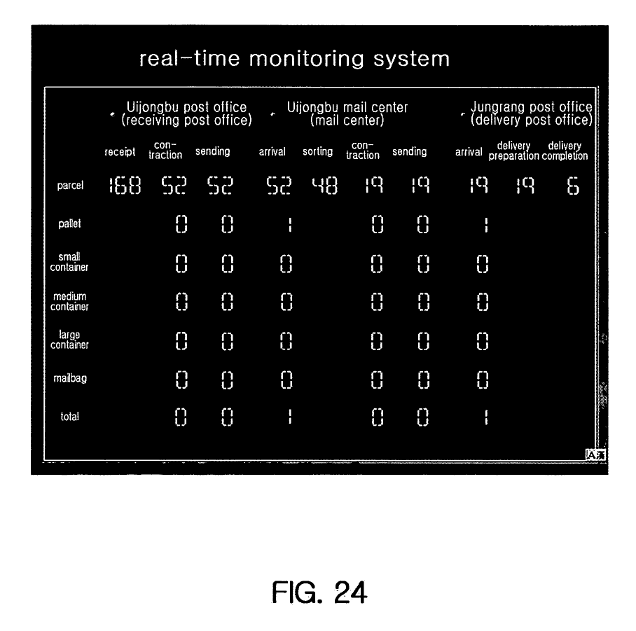

FIG. 24 is a view illustrating a screen for displaying a process state of a real-time monitoring system according to an embodiment of the present invention. The real-time monitoring system is a system for monitoring a state of a postal logistics process of the above-described systems in real-time, and the display screen thereof is as shown in FIG. 24. For example, the real-time monitoring system displays receiving, contracting and sending information of the postal matter for each post office, and postal type information (for example, a pallet, a small-sized container, a large-sized container and a mailbag, etc.) in real-time. As shown in FIG. 24, in a case where the postal matters received in a Uijongbu post office are delivered to a Jungrang post office via a Uijongbu mail center, the postal matter process state is displayed in real-time.

As shown in FIG. 24, the real-time monitoring system has a real-time state and statistics management function with respect to the postal matter and container which are sent and arrive through the receiving post office, the mail center and the collection and delivery post office, and can confirm a state and statistics of the postal matter and container for each date and for each destination.

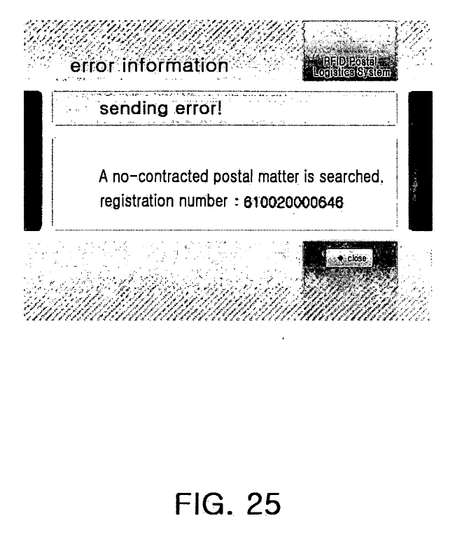

FIG. 25 is a view illustrating a screen for displaying a sending error of systems included in an apparatus for processing postal logistics according to an embodiment of the present invention. Referring to FIG. 25, the above systems included in the apparatus for processing postal logistics according to an embodiment of the present invention compare the postal matter information read through the RFID reader with the postal matter information transmitted through the postal logistics system 500 as shown in FIG. 1, and, when the postal matter information read through the RFID reader is different from the postal matter information transmitted through the postal logistics system 500, the sending error is displayed as shown in FIG. 25. For example, FIG. 25 illustrates a screen for displaying mistaken-arrived or non-arrived parcels, mailbags or boxes when performing the overall-recognition of the parcels, mailbags or boxes which are arrived at the receiving post office, the mail center and the delivery post office.

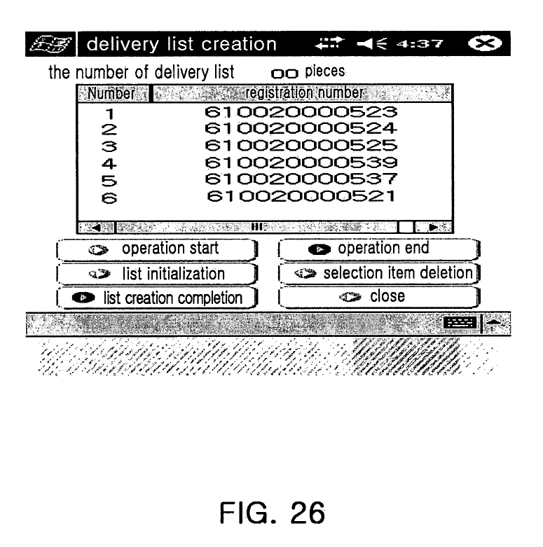

FIG. 26 is a view illustrating a screen for displaying a delivery result of the postal matters according to an embodiment of the present invention. Particularly, FIG. 26 is a view illustrating a screen for displaying the overall-recognition of the delivery parcels using the portable RFID terminal (for example, a PDA, etc.) when confirming the delivery parcels for each RFID-based postman. Referring to FIG. 26, an order and a registration number of a list of overall-recognized parcels are displayed on the screen.

On the other hand, the method for processing postal logistics using RFID according to an embodiment of the present invention may be employed as a code in a computer-readable recoding medium. The computer-readable recoding medium includes any type of recoding apparatuses in which computer-readable data are stored. For example, the computer-readable recoding medium includes a ROM, a RAM, a CD-ROM, a magnetic tape, a floppy disc, optical data storage, and the like. In addition, the computer-readable recoding medium includes a recoding medium for employing a carrier wave which is transmitted through an internet. In addition, by dispersing the computer-readable recoding medium in network-connected computer systems, the code in the computer-readable recoding medium may be stored and executed in the computer systems according to the dispersed method.

As apparent from the above description, the present invention provides an apparatus for processing postal logistics and a method using the same, wherein it is possible to rapidly perform postal logistics processing (particularly, a parcel processing service, etc.) by automating a postal logistics process, and a method using the same. In addition, the present invention provides an apparatus for processing postal logistics and a method using the same, wherein, it is possible to easily process postal logistics by decreasing time loss and manpower loss due to barcode attachment and barcode scanning when processing postal logistics. In addition, the present invention provides an apparatus for processing postal logistics and a method using the same, wherein, it is possible to accurately perform a postal matter sorting and comparison operation in a delivery and collection post office when processing postal logistics. In addition, the present invention provides an apparatus for processing postal logistics and a method using the same, wherein, it is possible to monitor a postal matter receipt and delivery process in real-time.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for processing postal logistics using Radio Frequency Identification (RFID), the apparatus comprising:
a postal matter receipt system for registering receipt information of received postal matter, and issuing an RFID tag corresponding to the postal matter receipt information;
a postal matter collection system for reading the RFID tag for the postal matter when the postal matter is transported from the postal matter receipt system, and automatically sorting the postal matter; and
a postal matter delivery system for receiving the postal matter from the postal matter collection system, reading the RFID tag for the postal matter, and delivering the postal matter to a corresponding postal destination.

2. The apparatus as set forth in claim 1, further comprising:
an information processing system for receiving the issued RFID and the reading result from each of the postal matter receipt system, the postal matter collection system and postal matter delivery system in real-time, and confirming transportation information with respect to the postal matter; and
a postal logistics system for receiving the issued RFID, the reading result and the transportation information via the information processing system, and managing the whole field of the postal matter.

3. The apparatus as set forth in claim 2, further comprising: a real-time monitoring system for receiving the transportation information transported from the information processing system in real-time, and displaying the received transportation information so as to monitor the transportation information in real-time.

4. The apparatus as set forth in claim 1, wherein the postal matter receipt system comprises:
an RFID processing unit for issuing the RFID tag for the received postal matter, outputting an RFID label corresponding to the issued RFID tag, and transmitting the issued result to the postal logistics system;
a received postal matter contract unit for contracting the RFID tag for the received postal matter and the RFID tag for the container, and transmitting the contracted information to the postal logistics system; and
a received postal matter sending unit for recognizing postal matter sending information corresponding to the RFID tag for the postal matter, and transmitting the sending information to the postal logistics system.

5. The apparatus as set forth in claims 1, wherein the postal matter collection system comprises:
an arrival processing unit for analyzing the RFID tag for the postal matter, recognizing the postal matter arrival information, and transmitting the arrival information to the postal logistics system;
a postal matter automatic sorting unit for automatically sorting the postal matter on the basis of the arrival information recognized through the arrival processing unit, and displaying the sorted information;
an arriving postal matter contraction unit for automatically contracting the postal matter sorted through the postal matter automatic sorting unit; and
an arriving postal matter sending unit for sending the postal matter automatically contracted through the arriving postal matter contraction unit.

6. The apparatus as set forth in claim 1, wherein the postal matter delivery system comprises:
a delivery postal matter arrival processing unit for analyzing the RFID tag for the postal matter transmitted through the postal matter collection unit, and determining whether the postal matter is mistaken-arrived/non-arrived or mis-sent/non-sent;
a delivery postal matter sorting unit for automatically sorting delivery postal matters for each postman when the postal matter has normally arrived according to the determination result;
a delivery postal matter overall-recognition unit for performing overall recognition of the automatically sorted postal matter; and
an delivery postal matter upload unit for receiving the delivery postal matter overall-recognition information through the delivery postal matter overall-recognition unit, and uploading the delivery postal matter overall-recognition information to the postal logistics system.

7. The apparatus as set forth in claim 6, wherein the delivery postal matter overall-recognition unit is composed of a portable radio frequency identification (RFID) apparatus.

8. A method for processing postal logistics using Radio Frequency Identification (RFID), the method comprising the steps of:
a) registering receipt information of postal matter in response to receipt of postal matter, and issuing an RFID tag for the postal matter;
b) reading the RFID tag for the postal matter when the postal matter is transported, and automatically sorting the postal matter; and
c) receiving the sorted postal matter, reading the RFID tag for the sorted postal matter, and delivering the postal matter to a corresponding postal destination.

9. The method as set forth in claim 8, further comprising: a step of receiving the transportation information transported from the information processing system in real-time, and displaying the received transportation information so as to monitor the transportation information in real-time.

10. The method as set forth in claim 8, wherein the step a) comprises:
a-1) issuing the RFID tag for the received postal matter;
a-2) outputting an RFID label corresponding to the issued RFID tag, and attaching the RFID label to the corresponding to postal matter;
a-3) uploading the RFID tag issued result to a postal e-logistics system;
a-4) automatically contracting the RFID tag for the received postal matter and the RFID tag for the container so as to generate contracted information;
a-5) uploading the contracted information to the postal logistics system;
a-6) recognizing postal matter sending information corresponding to the RFID tag for the postal matter; and
a-7) uploading the postal matter sending information to the postal logistics system.

11. The method as set forth in claim 8, wherein the step b) comprises:
b-1) analyzing the RFID tag for the postal matter, and recognizing postal matter arrival information;
b-2) uploading the arrival information to the postal logistics system;
b-3) automatically sorting the postal matter on the basis of the arrival information, and displaying the sorted information;
b-4) automatically contracting the sorted postal matter; and
b-5) sending the contracted postal matter.

12. The method as set forth in claim 8, wherein the step c) comprises:
c-1) analyzing the transmitted RFID tag for the postal matter, and determining whether the postal matter has normally arrived;
c-2) automatically sorting delivered postal matters for each postman when the postal matter has normally arrived;
c-3) performing overall recognition of the automatically sorted postal matter so as to generate the overall recognition information for the postal matter; and
c-4) uploading the overall recognition information for postal matter to the postal logistics system.

13. The method as set forth in claim 12, wherein said step c-3) for performing overall recognition of the automatically sorted postal matter is performed using a portable radio frequency identification (RFID) apparatus.

14. A method for processing postal logistics using Radio Frequency Identification (RFID), the method comprising the steps of:
a) inputting a container identification number (ID) to an RFID tag for a container;
b) storing a zip code of a container requesting office and information of a sending office in the RFID tag for the container when the container is requested from a container requesting office, attaching an office nametag corresponding to the RFID tag for the container, and attaching the office nametag to the container;
c-3) storing vehicle information in an RFID tag for the transportation vehicle, wherein the transportation vehicle transports the container to the container requesting office; and
c-4) loading the container to the transportation vehicle, recognizing the vehicle information and the loaded container information, and uploading the recognized information to the postal logistics system.

15. The method as set forth in claim 14, further comprising:
c-5) recognizing the RFID tag for the transportation vehicle and the RFID tag for the container when the container arrives at the container requesting office via the transportation vehicle, and uploading the recognized information to the postal logistics system; and
c-6) comparing -sending items of the container with arrival items of the container, removing the office nametag when the sending items match with the arrival items, and resetting the information of the RFID tag for the container in order to reuse the container.

16. A method for processing postal logistics using Radio Frequency Identification (RFID), the method comprising the steps of:
a) inputting a container identification number (ID) to an RFID tag for a container;
b) generating container office nametag information which includes a zip code of a container requesting office and a zip code of a container sending office when the container is requested from a container requesting office, and uploading the container office nametag information to an office nametag management apparatus or a postal e-logistics system;
c) storing the office nametag information in the RFID tag for the container, printing the office nametag, and attaching the office nametag to the container;
d) determining whether the container has normally arrived at the container requesting office, and removing the office nametag when the container has normally arrived; and
e) deleting the office nametag information stored in the RFID tag for the container.
